(19) United States
(12) Patent Application Publication
(10) Pub. No.: US 2025/0289604 A1
(43) Pub. Date: Sep. 18, 2025

(54) SYSTEM AND METHOD FOR PACKAGING PRODUCTS

(71) Applicant: OPTIMA nonwovens GmbH, Schwäbisch Hall (DE)

(72) Inventor: Georg Pfeifer, Schwäbisch Hall (DE)

(73) Assignee: OPTIMA nonwovens GmbH, Schwäbisch Hall (DE)

(21) Appl. No.: 18/860,670

(22) PCT Filed: Feb. 2, 2023
(86) PCT No.: PCT/EP2023/052516

§ 371 Date: Oct. 27, 2024

(30) Foreign Application Priority Data
Apr. 27, 2022 (DE) 10 2022 204 079.1

(51) Int. Cl. B65B 25/14; B65B 1/32; B65B 35/30

(52) U.S. Cl. CPC B65B 25/146; B65B 1/32; B65B 35/30

(57) ABSTRACT

The invention relates to a system and to a method for packaging product, in particular for packaging hygiene products such as diapers, panty liners, sanitary pads, incontinence products, wet wipes, toilet paper, paper towel rolls or the like, wherein individual products (3) are combined in several process steps (101, . . . , 111) in a packaging unit comprising a packaging material and several individual products (3) surrounded by the packaging material at least in regions, wherein an individual product (3) and/or a group comprising several individual products (3) and/or the packaging material are manipulated and/or moved by a transport element (20) moved relative to a transport surface (21) in controlled manner during at least one process step and/or for transport between two process steps, wherein the transport element (20) and the transport surface (21) are parts of a transport system (2) comprising the transport surface and several transport elements (20) movable relative to the transport surface (21) independently of one another and simultaneously in a speed and/or position controlled manner.

### TECHNICAL FIELD AND PRIOR ART

The invention relates to a system and to a method for packaging products. The invention relates in particular to a system and to a method for packaging hygiene products, such as diapers, panty liners, sanitary pads, incontinence products, wet wipes, toilet paper, paper towel rolls or the like.

Products to be packaged are taken over from stock or from a manufacturing line, as a rule as individual products, and combined in a packaging unit comprising a packaging material and several individual products surrounded at least in regions by the packaging material. The individual products, a unit comprising several individual products, and/or the packaging unit, are suitably handled in one or more process steps, for example the individual products are turned, folded, checked, combined in stacks or in groups with several stacks, units comprising several individual products are conveyed to a packaging material, the packaging material is sealed, labeled and printed, and packaging units are dispensed.

Various devices are known for handling and/or transporting the products during or between the process steps. For example, a stacking device for forming stacks from individual products delivered one behind the other is known from EP1663823 B1, comprising a plurality of compartments moved along a closed route and into each of which a single product is inserted, wherein a stack of products is then ejected from several adjacent compartments. A transfer device is known from EP1670706 B1 that receives singly delivered products inside pockets and conveys them to a stacking device with compartments. During conveying, the products receive a speed component in the direction of movement of the compartments, whereas they were decelerated to a standstill in their previous direction.

### OBJECT AND SOLUTION

It is an object of the invention to provide a system and a method for packaging products, in particular for packaging hygiene products such as diapers, panty liners, sanitary pads, incontinence products, wet wipes, toilet paper, paper towel rolls or the like, which have high flexibility.

This object is achieved by the system having the features of claim 1 and by the method having the features of claim 6. Further advantageous embodiments result from the dependent claims.

In accordance with a first aspect, a system is provided for packaging products, in particular for packaging hygiene products such as diapers, panty liners, sanitary pads, incontinence products, wet wipes, toilet paper, paper towel rolls or the like, which is configured to combine individual products in a packaging unit comprising a packaging material and several individual products surrounded by the packaging material at least in regions in several process steps, wherein the system comprises a transport system with a transport surface, with several transport elements and with a control unit, wherein the control unit is configured to control actuators on the transport surface and/or on the transport elements so that the transport elements are movable relative to the transport surface independently of one another and simultaneously in a speed and/or position controlled manner, and wherein at least some of the transport elements are configured to move individual products and/or groups comprising several individual products for transport between two process steps and/or to move and/or manipulate individual products and/or groups comprising several individual products and/or the packaging material during at least one process step.

In accordance with a second aspect, a method is provided for packaging products, in particular for packaging hygiene products such as diapers, panty liners, sanitary pads, incontinence products, wet wipes, toilet paper, paper towel rolls or the like, wherein individual products are combined in a packaging unit comprising a packaging material and several individual products surrounded by the packaging material at least in regions in several process steps, and wherein individual products and/or groups comprising several individual products and/or the packaging material are manipulated and/or moved by a transport element moved relative to a transport surface in a speed and/or position controlled manner during at least one process step and/or for transport between two process steps, wherein the transport element and the transport surface are parts of a transport system comprising the transport surface and several transport elements movable relative to a transport surface independently of one another and simultaneously in controlled manner.

In connection with the application, the terms “a” or “an” are generally used as the indefinite terms and not as “one” in the numerical sense. In particular, it is provided in an embodiment that an individual product or a group comprising several individual products is manipulated and/or moved by two or more transport elements moved relative to the transport surface in a speed and/or position controlled manner during a process step and/or for transport between two process steps. In an embodiment, several transport surfaces are also provided, wherein the transport surfaces have differing orientations.

Manipulation of an individual product or of a group of individual products and/or of the packaging material refers here to any effect on the individual product, on the group or on the packaging material in which a state is changed, for example by turning, shifting, folding, compacting, uprighting of a carton or the like. Process steps in connection with the application refer to any steps during packaging of products, comprising process steps for handling of individual products such as manipulation of an individual product by turning, shifting, folding, compacting or the like, to process steps for process control such as weighing, to process steps for stacking or grouping of individual products or of groups of individual products, and to process steps in which materials are added, changed or removed, and others.

A transport system comprising a transport surface and transport elements movable relative thereto is also referred to as a planar transport system. The transport surface is designed in an embodiment as a stator. The transport elements are movable with three degrees of freedom, in at least one plane parallel to the transport surface, for changing a position and an orientation. The transport system is designed in advantageous embodiments such that a movement of the transport elements relative to the transport surface is possible with six degrees of freedom. This ensures a high flexibility. Movement of the transport elements relative to the transport surface is contactless or floating in some embodiments of the transport system. A corresponding transport system is for example known from DE102018209401 A1, to which reference is made here in full. The application is however not restricted to the use of a transport system known from DE102018209401 A1.

In an embodiment, the transport surface is arranged in a horizontal plane. Embodiments are however also conceivable in which a vertically arranged transport surface is alternatively or additionally provided.

A use of a transport system of this type for transporting individual products or groups of individual products in a system for packaging permits a flexible arrangement of individual stations for performing the process steps, and a flexibly configurable process sequence. The transport elements are optionally conveyable or not conveyable to individual stations for performance of a process step. For example, it is conceivable that in one process step, an additional product is to be optionally provided in the packaging unit, wherein the transport elements are accordingly conveyed optionally to a station for performing a process step to add an additional product. Alternatively or additionally, an individual product or a group of individual products may be conveyed to a checking station at regular or irregular intervals for process monitoring.

Alternatively or additionally, it is provided in an embodiment that the groups of individual products are conveyed to various packaging material stations at which different packaging materials are processed. In an embodiment, it is further provided that conveying to different closing stations, for example different welding stations, takes place depending on a packaging material used and/or on other process parameters. Different process steps or identical process steps with different process parameters are performable at the various closing stations.

In an embodiment, it is provided that at least one process step is performable in parallel at two or more stations. This enables a process sequence to be performed in parallel at least in some sections to achieve a higher speed. In particular, it is provided in an embodiment that a process step for closing the packaging material is performed in parallel at two or more stations for that purpose.

A flexible adjustment of the system is also possible by adding or removing stations and/or by location changes of individual stations.

It is further possible that transport elements are repeatedly conveyed to a station, for example for repeated performance of a process step at various times in the process sequence and/or for repeating a process step in the event of a fault.

In an embodiment, the transport elements are moved at varying speeds over the transport surface, so that a distance between the transport elements is variable. It is provided in an embodiment that a distance for checking, for example by metal detectors, is increased for printing and/or for weighing.

At least some of the transport elements are configured to move individual products and/or groups comprising several individual products for transport between two process steps and/or to move and/or manipulate them during at least one process step. In an embodiment, the transport elements have for that purpose suitable receptacles, supporting elements and/or holding elements, by which individual products and/or groups of individual products are secured during transport on the transport element. In an embodiment, transport elements have a suction or vacuum holding device for transporting individual products. Alternatively or additionally, transport elements have in an embodiment cassettes into which individual products are insertable. In an embodiment, the cassettes have compartments, wherein individual products are each receivable inside one compartment. Alternatively or additionally, a separate mobile cassette with or without compartments for individual products is provided in a further embodiment, wherein the cassette is movable by one transport element or by several transport elements. The system has in an embodiment both transport elements with cassettes and several separate cassettes.

In an embodiment, it is provided that several transported items, i.e. several individual products, individual products and groups and/or several groups, are simultaneously transported, at least temporarily, with one transport element, wherein the process steps corresponding to the individual transported items are performed at the respective stations.

In an embodiment, it is provided that a function unit for performing a process step is provided on a transport element. A function unit refers, in connection with the application, to a device designed depending on the process step to perform said process step. By the function unit, it is possible to perform a process step-or several process steps-during transport of transported items. The function unit may also be moved by the transport element into different positions in order to perform process steps by the function unit, which is stationary or moved to different locations. Depending on the design of the function unit, manipulation of the transported item and/or checking of the transported item, for example weighing of the transported item, is performable on the transport element.

Alternatively or additionally, it is provided in an embodiment that a weight of a transported item received by a transport element is determined from a setting force for controlling the transport surface for the transport element. In other words, the transported item is weighed by the transport system. In an embodiment, weighing is performed for quality or error control. For example, in an embodiment the weight of an individual product is recorded when it is received.

In an embodiment, the control unit is configured to move two or more transport elements relative to the transport surface in coordinated manner for performing a process step. A manipulation of a received transported item is possible by the two or more transport elements. In an embodiment, the movement is used for a manipulation of the transported item, for example compression, folding, correction of folding errors or the like. For example, in an embodiment two transport elements are movable relative to one another such that a transported item arranged between them is compacted or compressed.

In a further embodiment, the control unit is configured to change a position and/or an orientation of a transport element with a received transported item relative to the transport surface for a subsequent process step, and/or to change a position and/or an orientation of a transport element relative to the transport surface for receiving a transported item. In an embodiment, flat products, in particular flat hygiene products such as panty liners, sanitary pads or diapers, are received flat from stock or from a manufacturing line on a transport element, wherein the transport element is operated in order to change its orientation, so that the received products are passed in an upright arrangement to a subsequent process step, for example for a stack. As a result, turning operations in the process steps can be dispensed with. In another embodiment, flat products, in particular flat hygiene products such as panty liners, sanitary pads or diapers, are received flat from stock or from a manufacturing line on a transport element, and set down on the transport element one above the other to form a stack, wherein the transport element is operated once it reaches a stack size in order to change its orientation for transporting the stack to a packaging material. Alternatively or additionally, it is provided that the transport element changes its position and/or orientation for receiving the products. The change in position and/or orientation is used in an embodiment to decelerate the received products. In other embodiments, the change in position and/or orientation is used to compensate for tolerances from a preceding process step and/or to compensate for tolerances while receiving from a production line. For example, it is conceivable to receive several individual products, by suitable movement of the transport element, on the transport element such that the individual products on the transport element are aligned in one plane. In other embodiments, the transport element is rotated, so that the transported item is received with a first orientation and with a second orientation diverging therefrom.

In a further embodiment, the control unit is configured to jointly convey two or more transport elements with received groups of individual products to a subsequent process step. The controlling is used for example to accumulate individual products to stacks, so that the stacks are conveyable to a unit for secondary packaging.

### BRIEF DESCRIPTION OF THE DRAWINGS

Further advantages and aspects of the invention can be derived from the claims and the description of examples of the invention that are explained in the following referring to the schematic figures. The drawing shows in:

FIG. 1 a system for packaging products in several process steps;

FIG. 2 a process step for receiving and lining up products;

FIG. 3 a process step for aligning products;

FIG. 4 a process step for compacting a stack of products;

FIG. 5 a process step for changing an orientation of a stack of products;

FIG. 6 a process step for grouping several stacks of products.

### DETAILED DESCRIPTION OF THE EXAMPLES

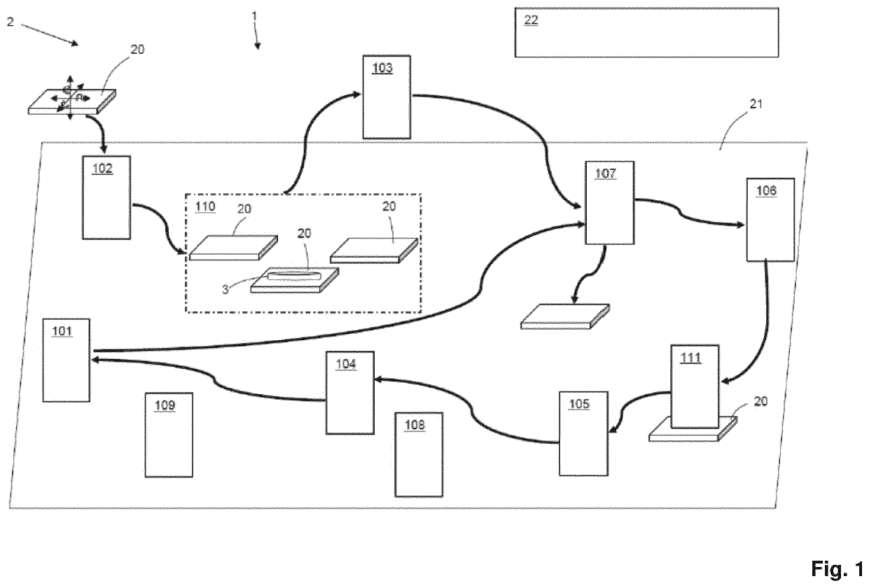

FIG. 1 shows schematically a system 1 for packaging products, in particular for packaging hygiene products such as diapers, panty liners, sanitary pads, incontinence products, wet wipes, toilet paper, paper towel rolls or the like, wherein the products are suitably handled or manipulated by the system 1 in eleven process steps 101, . . . , 111. In the process steps 101, . . . , 111, individual products are turned, folded, checked, combined in stacks or in groups with several stacks, depending on the specific use, units comprising several individual products are conveyed to a packaging material, the packaging material is sealed, labeled and printed, and packaging units are dispensed.

The system 1 comprises a transport system 2 with a transport surface 21, with several transport elements 20 and with a control unit 22. As shown schematically by arrows, the transport elements 20 are movable relative to the transport surface 21 with six degrees of freedom.

The transport system 2 is used in the example shown in FIG. 1 for transporting individual products or groups of individual products to stations for performance of the process steps 101, . . . , 111. In the example shown, actuators on the transport surface 21 and/or on the transport elements 22 are operated by the control unit 22, in order to move several transport elements 20 relative to the transport surface 21, independently of one another and simultaneously in a speed and/or position controlled manner, for transporting of individual products and/or of groups comprising several individual products between two process steps 101, . . . , 111.

Control is performed such that a transport element 20 undergoes for example the process steps 102, 110, 103, 107, 106, 111, 105, 104, 101 and 107. The process steps 108, 109 are not performed in the process sequence shown in FIG. 1. In other embodiments, these process steps 108, 109 are performed additionally or alternatively to other process steps. In the process sequence shown, the process step 107 is performed twice. This is for example a checking step which is performed after the process steps 102, 110 and 103 and at the end of the process sequence.

In the example shown, all stations for performing the process steps are arranged on the transport surface 21, with the exception of a station for performing the process step 103. This configuration is however only schematic.

In the example shown, the transport elements 20 are not only used to transport the products; instead, it is provided in process step 110 that two transport elements 20 are operated to perform a movement relative to the transport surface 21 during performance of the process step, such that an individual product is manipulated, for example turned, folded and/or compressed, by the transport elements 20. It is also provided in an embodiment that two or more transport elements 20 in one process step

Further, in the example shown the process step 111 is performed on a transport element 20. In an embodiment, the process step 111 is performable during a movement of the transport element 20 between the process steps 106 and 105.

The process sequence shown in FIG. 1 is only by way of example, and numerous variants are conceivable.

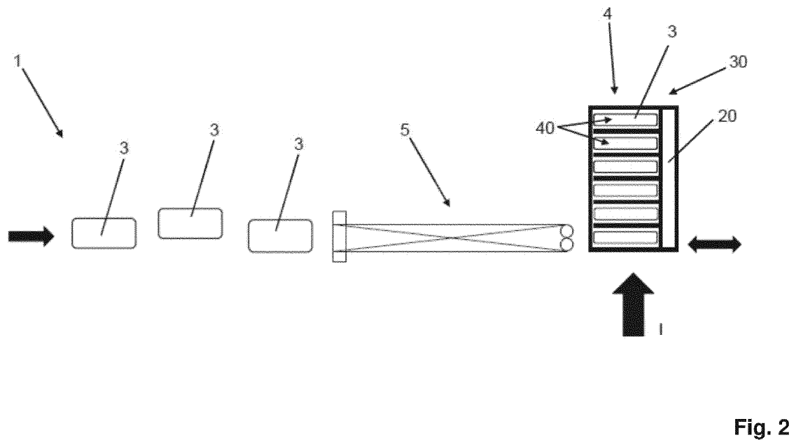

FIG. 2 shows schematically, in a plan view, a process step for receiving and lining up individual products 3 in a stack 30. In the example shown, a transport element 20 is provided for that purpose, which has a cassette 4, shown schematically, with a plurality of compartments 40, wherein an individual product 3 is receivable inside each compartment 40. The individual products 3 are conveyed in a product flow in a first alignment, in a direction indicated schematically by an arrow. In the example shown, a turning device 5 is provided, by which an orientation of the individual products 3 is changed. The turning device 5 shown is arranged stationary, wherein the transport element 20 is movable in a direction I relative to the turning device 5 in order to position a compartment 40 opposite the turning device 5 for receiving an individual product 3. In an alternative embodiment, a turning device 5 is dispensed with, wherein a transport element 20 with a suitably oriented cassette 4 is moved vertically to a drawing plane according to FIG. 2 for receiving and lining up the individual products 3.

In an embodiment, weighing takes place when individual products 3 are received. In particular, in an embodiment a weight of an individual product received by the transport element 20 is determined from a setting force for controlling the transport surface 21 for the transport element 20. Weighing while receiving individual products 3 allows irregularities to be detected at an early stage. In an embodiment, an associated transport element 20 is subjected to a manually or automatically performed check if an irregularity occurs.

As indicated schematically by a double arrow in FIG. 2, the transport element 20 is, while receiving individual products 3, also movable relative to the turning device 5 in the conveying direction of the individual products 3, in order to compensate for a production-related offset between the individual products 3 in the product flow.

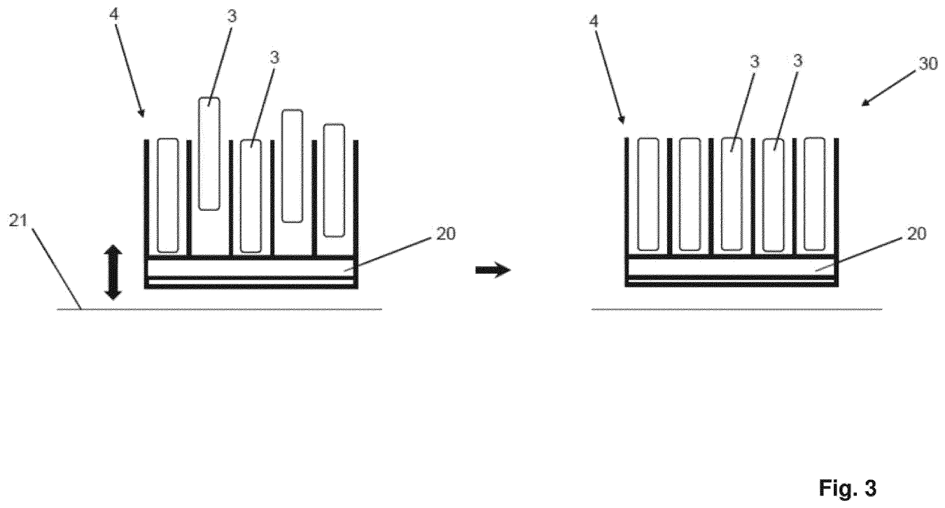

In another embodiment, no movement of the transport elements 20 in the conveying direction of the individual products 3 takes place, in contrast to FIG. 2. If an alignment of the individual products 3 is necessary, this may take place in a subsequent process step as shown schematically in FIG. 3.

FIG. 3 shows schematically a process step for aligning a stack 30 of individual products 3 lined up on a transport element 20. The individual products 3 are initially arranged without any order inside a cassette 4 arranged on the transport element 20. The transport element 20 is moved back and forth relative to the transport surface 21 as shown schematically by an arrow, so that the individual products 3 are aligned on a floor of the cassette 4 with their downward facing ends. Depending on the embodiment, the movement takes place vertically to the transport surface 21 and/or with another direction component.

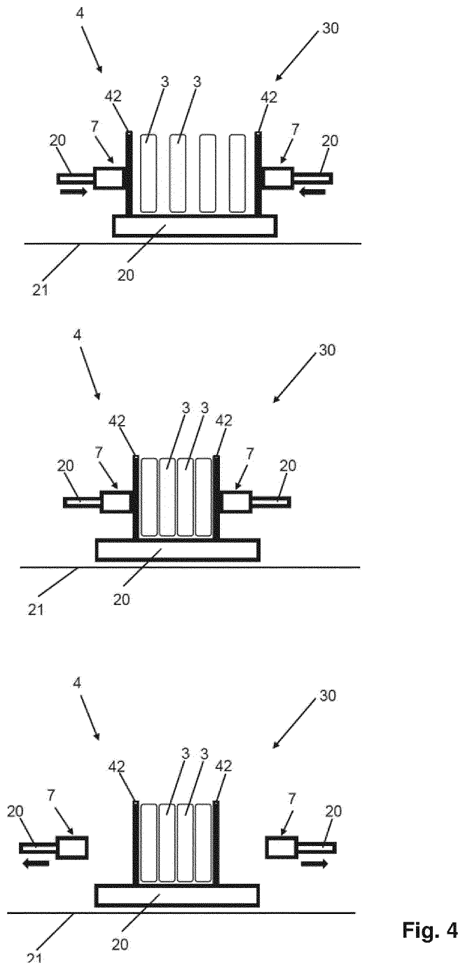

FIG. 4 shows schematically a process step for compacting a stack 30 of individual products 3 lined up on a transport element 20. The stack of individual products 3 is arranged in a cassette 4 arranged on the transport element 20. The cassette 4 has two movable walls 42 arranged at opposite ends. For compacting the stack 30, the two walls 42 are moved towards one another. In an alternative embodiment, a movable wall and a stationary wall are provided.

Two plungers 7 are provided for movement of the walls 42. In an embodiment, the plungers 7 are provided stationary at a station, wherein the transport element 20 with the stack 30 of individual products 3 is moved between the plungers for compacting. In the embodiment shown, the plungers 7 are each provided on one transport element 20, wherein the transport elements 20 are moved relative to one another to compact the stack 30.

In the example shown, the transport elements 20 with the plungers 7 are movable relative to the transport surface 21. In an alternative embodiment, a second transport surface is provided which is arranged vertical to the transport surface 21 shown, wherein the transport elements 20 with the plungers 7 are movable relative to the second transport surface.

In yet another embodiment, the plungers 7 are attached to a transport element 20 by mounting structures, so that a distance between the transport elements 20 of the plungers 7 and the transport surface 21 may be reduced while maintaining the height of the plungers 7.

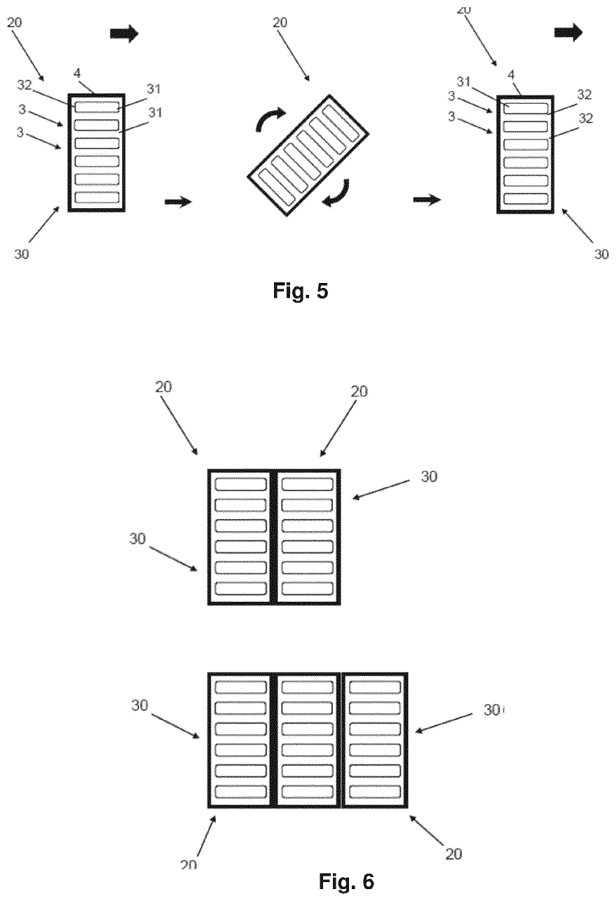

FIG. 5 shows schematically, in a plan view, a process step for changing an orientation of a stack 30 of individual products 3 lined up on a transport element 20. The stack 30 of individual products 3 is arranged in a cassette 4 arranged on the transport element 20. The orientation is initially such that first ends 31 of the individual products 3 are arranged at the front in a transport direction indicated schematically by an arrow, and second ends 32 at the rear. The terms “first” and “second” are used here only to distinguish, and not to indicate any sequence. The transport element 20 is rotated about an axis vertical to the transport surface, so that after rotation the second ends 32 of the individual products are arranged at the front in a transport direction indicated schematically by an arrow. The change in orientation shown is only by way of example, and numerous variants are conceivable.

FIG. 6 shows schematically, in a plan view, a process step for grouping several stacks 30 which are each arranged on a transport element 20. In the embodiment shown in FIG. 6, the stacks 30 of a row at the bottom in the illustration are arranged with a uniform orientation, and the stacks 30 of a row at the top in the illustration with a differing orientation for grouping. This arrangement is however only by way of example. In other embodiments, the stacks 30 are alternatively or additionally arranged at least partially shifted by 90° to one another.

In an embodiment, it is further provided that in the process step for grouping of several stacks 30, the transport elements 20 are additionally moved vertically to the transport surface in order to position stacks 30 one above the other.

The group of stacks 30 in accordance with FIG. 6 is, in an embodiment, conveyed in a subsequent process step, not shown, to a packaging material, not shown, for example to a foil bag. The stacks 30 are separated from the transport elements 20. For separating the stacks from the transport elements 20, the transport elements 20 are set at an angle in an embodiment, so that the stacks 30 slide off the transport elements 20. Additionally or alternatively, the stacks 30 are pushed out by suitable pushers or similar elements in an embodiment.

The transport elements 20 are, after transfer of the stacks 30, moved into a starting position in an embodiment, for example for receiving and lining up individual products in accordance with the process step shown in FIG. 2.

In the embodiments shown in FIGS. 3 to 6, the transport elements 20 each have cassettes 4 without compartments. In other embodiments, transport elements having cassettes 4 with compartments 40 similar to FIG. 2 are provided for these or similar process steps.

In yet other embodiments, the transport elements 20 do not have cassettes 4 for receiving and transporting the individual products 3. The individual products 3 are held on the transport element 20 for example by the force of gravity or by a suitable holding device.

The embodiments shown are only by way of example, and numerous variants are conceivable for use of a planar transport system 2 in a system for packaging products.

1. A system for packaging products, in particular for packaging hygiene products such as diapers, panty liners, sanitary pads, incontinence products, wet wipes, toilet paper, paper towel rolls or the like, which is configured to combine individual products in several process steps in a packaging unit comprising a packaging material and several individual products surrounded by the packaging material at least in regions, wherein the system comprises a transport system with a transport surface, with several transport elements and with a control unit, wherein the control unit is configured to control actuators on the transport surface and/or on the transport elements, so that the transport elements are movable relative to the transport surface independently of one another and simultaneously in a speed and/or position controlled manner, and wherein at least some of the transport elements are configured to move individual products and/or groups comprising several individual products for transport between two process steps and/or to move and/or manipulate individual products and/or groups comprising several individual products and/or the packaging material during at least one process step.

2. The system according to claim 1, wherein a function unit for performing a process step is provided on a transport element.

3. The system according to claim 1, wherein the control unit is configured to move two or more transport elements relative to the transport surface in coordinated manner for performing a process step.

4. The system according to claim 1, wherein the control unit is configured to change a position and/or an orientation of a transport element with a received transported item relative to the transport surface for a subsequent process step, and/or to change a position and/or an orientation of a transport element relative to the transport surface for receiving a transported item.

5. The system according to any of claim 1, wherein the control unit is configured to jointly convey two or more transport elements with received groups of individual products to a subsequent process step.

6. A method for packaging products, in particular for packaging hygiene products such as diapers, panty liners, sanitary pads, incontinence products, wet wipes, toilet paper, paper towel rolls or the like, wherein individual products are combined in several process steps in a packaging unit comprising a packaging material and several individual products surrounded by the packaging material at least in regions, wherein an individual product and/or a group comprising several individual products and/or the packaging material are manipulated and/or moved by a transport element moved relative to a transport surface in controlled manner during at least one process step and/or for transport between two process steps, wherein the transport element and the transport surface are parts of a transport system comprising the transport surface and several transport elements movable relative to the transport surface independently of one another and simultaneously in a speed and/or position controlled manner.

7. The method according to claim 6, wherein a weight of a transported item received by a transport element is determined from a setting force for controlling the transport surface for the transport element.

8. The method according to claim 6, wherein two or more transport elements are moved relative to the transport surface in coordinated manner for performing a process step.

9. The method according to claim 6, wherein a position and/or an orientation of a transport element with a received transported item is changed relative to the transport surface in order to position and/or orient the transported item for a process step, and/or a position and/or an orientation of a transport element relative to the transport surface is changed for receiving a transported item.

10. The method according to claim 6, characterized in that wherein two or more transport elements with received groups of individual products are conveyed jointly to a subsequent process step.
